(19) United States
(12) Patent Application Publication
(10) Pub. No.: US 2017/0091832 A1
(43) Pub. Date: Mar. 30, 2017

(54) PRODUCT COMPONENT DRIVEN REVIEW AGGREGATION

(71) Applicant: International Business Machines Corporation, Armonk, NY (US)

(72) Inventors: Nader M. Nassar, Yorktown Heights, NY (US); Annette S. Riffe, Chelmsford, MA (US); Robert Spremulli, Nashua, NH (US)

(21) Appl. No.: 14/867,000

(22) Filed: Sep. 27, 2015

(51) Int. Cl. G06Q 30/02; G06F 17/30

(52) U.S. Cl. CPC G06Q 30/0276; G06Q 30/0282; G06F 17/30864

(57) ABSTRACT

Embodiments of the invention provide a method, system and computer program product for product component driven review aggregation. A product component driven review aggregation method includes receiving a request in an interface to an aggregator executing in memory of a computer, identifying a product from the request and determining an underlying component of the product. The method also includes generating a query based upon the underlying component and executing the query in a search engine. The method yet further includes receiving from the search engine a multiplicity of content pertaining to the underlying component and aggregating the multiplicity of the content by the aggregator into a single document. Finally, the method includes displaying by the aggregator the single document in a display of the computer.

### BACKGROUND OF THE INVENTION

Field of the Invention

The present invention relates to product review publication and more particularly to aggregating product reviews for a product.

Description of the Related Art

The advent of the global Internet has resulted in a global means not only for promoting the sale of products to a massive set of geographically diverse potential customers, but also to allow for the continuous sharing of individual opinions in respect to those products. These individual opinions couched in the form of product reviews are shared in many different forms over the Internet and in particular, the World Wide Web, ranging from traditional journalistic articles to fragmented comments on social media blog spaces. Thus, one seeking to understand the communal opinion of a product need only utilize a search engine searching for documents published about the Web containing one or more keywords—generally the name of the product of interest.

The process of collecting multiple different opinions regarding a product of interest is known as “aggregation”. Aggregation can be done manually through the tedious process of iterative search and collection of data. Aggregation more typically is performed in an automated manner using programmatic logic configured to perform the iterative searching process. Known as an aggregator, the user interface to the results of the aggregation process often is presented as part of a larger Web presence, such a product review oriented Web site or an online retail outlet.

The process of aggregation for a product is limited to a product of specific identity, be this identity a product brand name or product type. However, this limitation often results in a substantial volume of product commentary being omitted from the aggregation. In this regard, it is to be understood that many different products are manufactured by the same entity, but branded and sold differently by different product distributors. As well, it is to be understood that in many circumstances, it is not the entire product that is of interest, but only an underlying component of the product providing a feature of interest. Aggregation based upon a product name, however, will not account for an underlying component of one manufacturer present in different products distributed by different distributors under different brand names.

### BRIEF SUMMARY OF THE INVENTION

Embodiments of the present invention address deficiencies of the art in respect to product review aggregation and provide a novel and non-obvious method, system and computer program product for product component driven review aggregation. In an embodiment of the invention, a product component driven review aggregation method includes receiving a request in an interface to an aggregator executing in memory of a computer, identifying a product from the request and determining an underlying component of the product. In this regard, the product of the product request can be a branded form of original equipment manufactured by a single manufacturer for multiple different distributers branding the original equipment differently from one another, and the underlying component is the original equipment.

The method also includes generating a query based upon the underlying component and executing the query in a search engine. The method yet further includes receiving from the search engine a multiplicity of content pertaining to the underlying component and aggregating the multiplicity of the content by the aggregator into a single document. Finally, the method includes displaying by the aggregator the single document in a display of the computer.

In one aspect of the embodiment, the multiplicity of content is filtered to content determined to be associated with an identity of an individual providing the request. For instance, content is determined to be associated with the identity of the individual when the content is retrieved from a Web site in which the individual is known to have contributed content. In another aspect of the embodiment, the multiplicity of content includes at least two different ratings of the underlying component based upon two different rating scales, and wherein the at least two different ratings are normalized by the aggregator into ratings of a common rating scale.

In another embodiment of the invention, a data processing system is configured for product component driven review aggregation. The system includes a host computing system that includes at least one computer with memory and at least one processor. The system also includes an aggregator executing in the memory of the host computing system and coupled to a search engine. Finally, the system includes a product component driven review aggregation module executing in the memory of the host computing system. The module includes program code enabled to receive a request in an interface to the aggregator, to identify a product from the request and to determine an underlying component of the product, to generate a query based upon the underlying component and executing the query in the search engine, to receive from the search engine a multiplicity of content pertaining to the underlying component, to aggregate the multiplicity of the content into a single document and to display the single document in a display of the host computing system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for product component driven review aggregation;

FIG. 2 is a schematic illustration of a data processing system configured for product component driven review aggregation; and,

FIG. 3 is a flow chart illustrating a process for product component driven review aggregation.

### DETAILED DESCRIPTION OF THE INVENTION

Embodiments of the invention provide for product component driven review aggregation. In accordance with an embodiment of the invention, a product query is received on behalf of an end user through a program interface to an aggregator executing in memory of a computer, and an underlying component is identified by the aggregator for the product. Thereafter, a query based upon the underlying component is generated in the aggregator and issued to a communicatively coupled search engine. In consequence, a multiplicity of content pertaining to the underlying component is retrieved by the search engine and aggregated by the aggregator into a single document. Optionally, the retrieved content is filtered based upon relevance of the retrieved content to the end user. As an additional option, different rating values computed for the underlying component and present in the retrieved content are normalized into a common range of ratings for the underlying component. Finally, the document is displayed in connection with the aggregator.

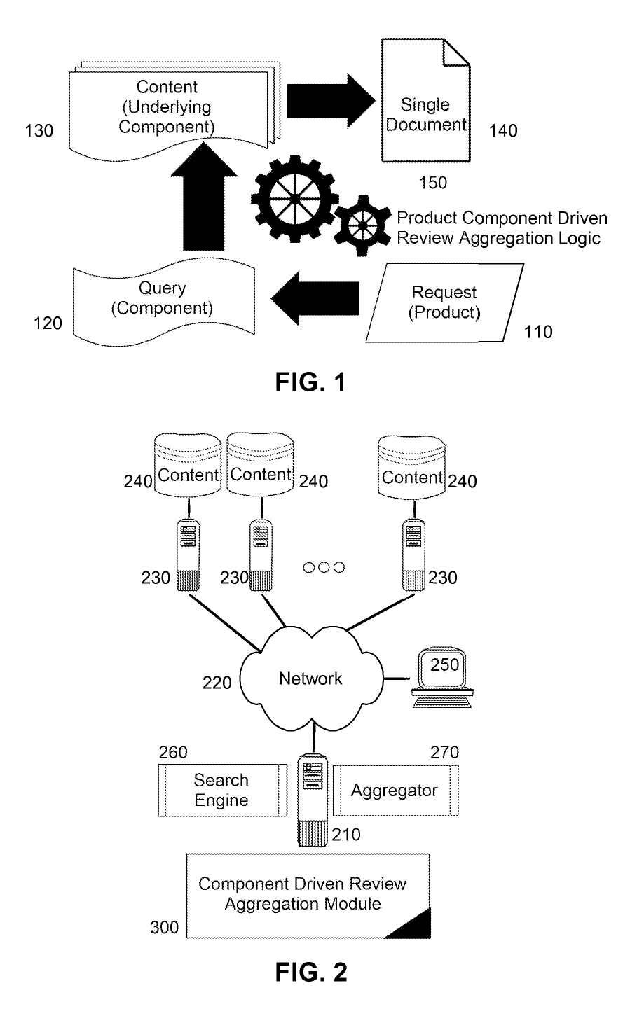

In further illustration, FIG. 1 pictorially shows a process for product component driven review aggregation. As shown in FIG. 1, a request 110 is received from a requesting end user in product component driven review aggregation logic 150 for a product review of a product, such as branded original equipment manufactured by an underlying manufacturer and sold under different brand names by different distributors. The logic 150 identifies a product from the request 110 and determines an underlying component of the product, such as the original equipment or one of several physical parts of the product. Thereafter, the logic 150 generates a query 120 for the underlying component and provides the query 120 to a search engine for execution. In response to the query 120, the search engine locates a multiplicity of content 130 in connection with the underlying component and the logic 150 aggregates the multiplicity of the content 130 into a single document 140 for display by the requesting end user.

The process described in connection with FIG. 1 is implemented in a data processing system. In yet further illustration, FIG. 2 schematically illustrates a data processing system configured for product component driven review aggregation. The system includes a host computing system 210 that includes one or more computers each with memory and at least one processor. The host computing system 210 supports the operation of both a search engine 260 and an aggregator 270. The search engine 260 is configured to execute search engine queries over computer communications network 220 to different content servers 230 serving content 240 to the search engine 260 in response to the queries. The aggregator 270 in turn is configured to aggregate the content 240 retrieved by the search engine 260 in a single document.

Of note, component driven review aggregation module 300 is coupled to the host computing system 210 and executes in the memory of the host computing system 210. The module 300 includes program code that is enabled to receive a product request from a client computer of an end user, identify from the request a product, determine an underlying component of the product, generate a query for review content corresponding to the underlying component, issuing the query to the search engine 260, receiving a multiplicity of the content 240 from the search engine 260 in response to the query, aggregating the multiplicity of the content 240 into a single document and returning the document to the end user for display in the client computer 250.

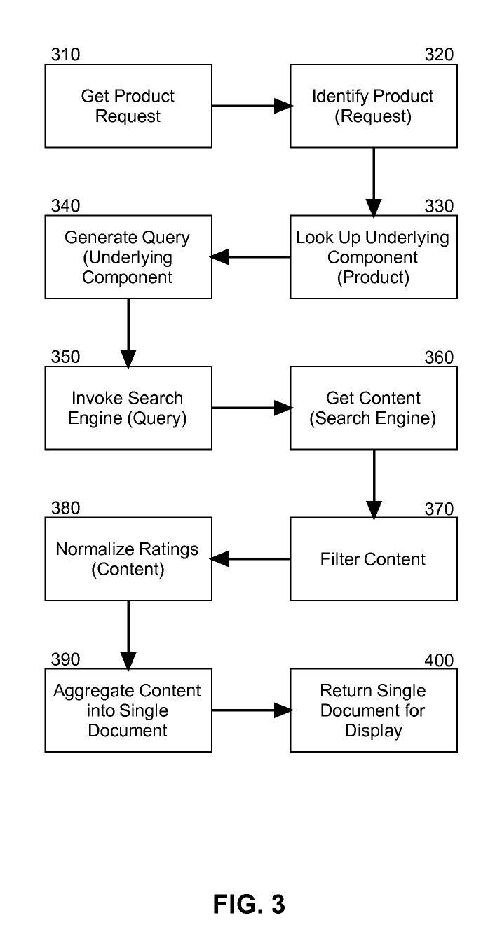

In even yet further illustration of the operation of the module 300, FIG. 3 is a flow chart illustrating a process for product component driven review aggregation. Beginning in block 310, a product request is received from an end user for review content pertaining to the product. In block 320, the product is identified from the request and in block 330, an underlying component for the product is determined, for example, in reference to a table correlating components to a product. In block 340 a query is generated to locate review content in connection with the underlying component. Thereafter, in block 350 the query is provided to a search engine for execution.

In block 360, a multiplicity of content is received from the search engine in connection with the query executed by the search engine. Thereafter, in block 370 the multiplicity of content is filtered for relevance. In this regard, the multiplicity of the content is filtered when the content derives from a source in which the end user had contributed content. As well, in block 380 rating values in the multiplicity of content are normalized into a common range of values. For instance, the different ranges of values can be correlated to a common range through respectively different conversion formulae in a table so as to readily provide for normalization of a particular rating value of a particular range of values. Thereafter, in block 390 the filtered content with normalized rating values is aggregated into a single document and in block 400 the single document is returned to the end user for display to the end user.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A product component driven review aggregation method comprising:
receiving a request in an interface to an aggregator executing in memory of a computer;
identifying a product from the request and determining an underlying component of the product;
generating a query based upon the underlying component and executing the query in a search engine;
receiving from the search engine a multiplicity of content pertaining to the underlying component;
aggregating the multiplicity of the content by the aggregator into a single document; and,
displaying by the aggregator the single document in a display of the computer.

2. The method of claim 1, wherein the multiplicity of content is filtered to content determined to be associated with an identity of an individual providing the request.

3. The method of claim 1, wherein content is determined to be associated with the identity of the individual when the content is retrieved from a Web site in which the individual is known to have contributed content.

4. The method of claim 1, wherein the multiplicity of content includes at least two different ratings of the underlying component based upon two different rating scales, and wherein the at least two different ratings are normalized by the aggregator into ratings of a common rating scale.

5. The method of claim 1, wherein the product of the product request is a branded form of original equipment manufactured by a single manufacturer for multiple different distributers branding the original equipment differently from one another, and the underlying component is the original equipment.

6. A data processing system configured for product component driven review aggregation, the system comprising:
a host computing system comprising at least one computer with memory and at least one processor;
an aggregator executing in the memory of the host computing system and coupled to a search engine; and,
a product component driven review aggregation module executing in the memory of the host computing system, the module comprising program code enabled to receive a request in an interface to the aggregator, to identify a product from the request and to determine an underlying component of the product, to generate a query based upon the underlying component and executing the query in the search engine, to receive from the search engine a multiplicity of content pertaining to the underlying component, to aggregate the multiplicity of the content into a single document and to display the single document in a display of the host computing system.

7. The system of claim 6, wherein the multiplicity of content is filtered to content determined to be associated with an identity of an individual providing the request.

8. The system of claim 6, wherein content is determined to be associated with the identity of the individual when the content is retrieved from a Web site in which the individual is known to have contributed content.

9. The system of claim 6, wherein the multiplicity of content includes at least two different ratings of the underlying component based upon two different rating scales, and wherein the at least two different ratings are normalized by the aggregator into ratings of a common rating scale.

10. The system of claim 6, wherein the product of the product request is a branded form of original equipment manufactured by a single manufacturer for multiple different distributers branding the original equipment differently from one another, and the underlying component is the original equipment.

11. A computer program product for product component driven review aggregation, the computer program product comprising a computer readable storage medium having program instructions embodied therewith, the program instructions executable by a device to cause the device to perform a method comprising:
receiving a request in an interface to an aggregator executing in memory of a computer;
identifying a product from the request and determining an underlying component of the product;
generating a query based upon the underlying component and executing the query in a search engine;
receiving from the search engine a multiplicity of content pertaining to the underlying component;
aggregating the multiplicity of the content by the aggregator into a single document; and,
displaying by the aggregator the single document in a display of the computer.

12. The computer program product of claim 11, wherein the multiplicity of content is filtered to content determined to be associated with an identity of an individual providing the request.

13. The computer program product of claim 11, wherein content is determined to be associated with the identity of the individual when the content is retrieved from a Web site in which the individual is known to have contributed content.

14. The computer program product of claim 11, wherein the multiplicity of content includes at least two different ratings of the underlying component based upon two different rating scales, and wherein the at least two different ratings are normalized by the aggregator into ratings of a common rating scale.

15. The computer program product of claim 11, wherein the product of the product request is a branded form of original equipment manufactured by a single manufacturer for multiple different distributers branding the original equipment differently from one another, and the underlying component is the original equipment.
